(19) United States
(12) Patent Application Publication
(10) Pub. No.: US 2015/0019383 A1
(43) Pub. Date: Jan. 15, 2015

(54) ONLINE VACATION RENTAL BOOKING SYSTEM

(71) Applicant: Huan Truong, Corona, CA (US)

(72) Inventor: Huan Truong, Corona, CA (US)

(21) Appl. No.: 14/494,440

(22) Filed: Sep. 23, 2014

Related U.S. Application Data
(63) Continuation-in-part of application No. 13/940,124, filed on Jul. 11, 2013.

(51) Int. Cl. G06Q 30/06; G06Q 10/02

(52) U.S. Cl. CPC G06Q 30/0627; G06Q 30/0645; G06Q 10/02
USPC 705/26.63

(57) ABSTRACT

A property search engine interface, having a plurality of coupled, color-coded, interactive cells each having a record therein. Cells are arranged in a grid format, a horizontal row is representative of a first characteristic, and a vertical column is representative of a second characteristic. A respective cell of the plurality of cells corresponds to the first characteristic and a second characteristic, and a cell color-coding of the cell is representative of a third characteristic. Each interactive cell contains a record corresponding to the third characteristic, and the record is selected by a search engine coupled to a vacation rental database. The first characteristic is a time characteristic, the second characteristic is an accommodation characteristic, and the third characteristic is an average nightly price characteristic. The record corresponds to an average nightly price record related to the time characteristic and the accommodation characteristic.

### CROSS-REFERENCES TO RELATED APPLICATIONS

This application is a continuation-in-part of U.S. application Ser. No. 13/940,124, filed Jul. 13, 2013 and entitled “ONLINE VACATION RENTAL BOOKING SYSTEM,” which is assigned to the same assignee hereof, and which is incorporated by reference in its entirety.

### BACKGROUND OF THE INVENTION

1. Field of Invention

The invention relates generally to booking systems, and more particularly, to an online vacation rental booking system.

2. Description of Related Art

Travel bookings are one of the largest components of e-commerce. Online travel websites help users find and book cheap flights, hotels, vacations, rental cars, bed and breakfasts, cruise lines, etc. Many websites include some sort of search engine technology to look for bookings within a certain timeframe, service class, geographic location, or price range.

One type of travel booking is vacation rentals. A vacation rental is the renting out of a place on a temporary basis to tourists as an alternative to a hotel, motel, or hostel. Vacation rentals are also referred to as vacation homes, villas, townhouses, condominiums, furnished apartments, houses, etc. Vacation rentals have long been a popular lodging option in Europe and Canada, and are increasingly becoming popular across the rest of the world.

Typically, major differences exist between a traveler that is planning to stay in a vacation rental and a traveler that is planning to stay in a hotel. A first major difference is the timing of the planning and stay, affecting the timeframe for the stay. The vacation rental traveler typically plans ahead more, has a longer stay planned, and has a more flexible vacation schedule. For example, if a traveler is just passing through town for one night and looking for lodging, often the most convenient option is a hotel. By contrast, a vacation rental is the best option for a traveler who has several months to plan his vacation from work or school and wants to stay for many days. Vacation rentals are usually less expensive, more spacious, closer to the local non-tourist cultural spots, and often have amenities only found in the more expensive hotels.

Another major difference between vacation rentals and hotels is the size of the lodging desired, affecting the number of bedrooms desired. Often times vacation rentals are better suited for larger groups, such as a family, requiring a specific number of bedrooms. If a single traveler is going on a trip, often the most convenient option is a hotel. By contrast, a person traveling with his family, pets, or a large group, often the best option is a vacation rental. Vacation rentals are more likely to feel like a home away from home. Vacation rentals can have many bedrooms and high end amenities such as a private pool or kitchen.

A problem with conventional vacation rental bookings is that it is challenging for a traveler having flexibility in travel times but not in the size of his group. Often times, the vacation rental traveler will plan his vacation several months in advance, look for which city or country to visit, look for which month to travel, and look for places that accommodate his entire family. When a traveler is planning his vacation from work or during summer break, often times he has a group size and trip length that makes hotel stays undesirable.

Conventional booking systems exist to book travel online. For example, U.S. Pat. Pub. No. 2010/0293011 to Lebreton is directed to a method of generating an offer for resources, such as a hotel room, which meets a customer request and satisfies at least one customer preference. In one embodiment, Lebreton illustrates a table having a one day period of time in the six columns (i.e., January 1st thru 6th) and six different hotels in the six rows (i.e., hotel 1, hotel 2, hotel 3, hotel 4, hotel 5, and hotel 6). Each cell within the table shows the hotel's availability and price for that specific day. This enables the traveler to see if one hotel, or a mixture of hotels, is available for the entire stay.

However, Lebreton falls short in that it does not help a traveler who has flexibility in terms of which month to travel, which city to travel to, and is looking for a specific or minimum number of bedrooms.

### SUMMARY OF THE INVENTION

Embodiments of the invention provide a property search engine interface, having a plurality of coupled, color-coded, interactive cells each having a record respectively therein. The cells are arranged in a grid format, wherein a horizontal row is representative of a first characteristic, and a vertical column is representative of a second characteristic. A respective cell of the plurality of cells corresponds to the first characteristic and a second characteristic, and a cell color-coding of the cell is representative of a third characteristic. Each of the interactive cells contains a record corresponding to the third characteristic, and the record is selected by a search engine coupled to a vacation rental database. The first characteristic is a time characteristic, the second characteristic is an accommodation characteristic, and the third characteristic is an average nightly price characteristic. The record corresponds to an average nightly price record related to the time characteristic and the accommodation characteristic. The accommodation characteristic is at least one of a number of bedrooms, a number of guests, or a bed size.

A plurality of coupled, interactive display cells have at least one record corresponding to the time characteristic, the accommodation characteristic, and the average nightly price record. Also, each of the display cells provide a property record, an accommodation record, a property type, and a property location. An entry page is provided, having a destination entry, a start date entry, an end date entry, a size entry, a guest number entry, and search engine activation device. Certain ones of the plurality of cells further are a second record corresponding to the third characteristic, where the second record comprises the number of locations corresponding to the third characteristic. Also, a horizontal header is above the plurality of cells and a vertical header is to a side of the plurality of cells.

In some embodiments, each of the plurality of coupled, interactive display cells is coupled to a geographic map having an interactive locator icon representative of the property location on the geographic map. Also, each of the plurality of coupled, interactive display cells is coupled to a geographic map representation having a feature chart corresponding to a plurality of features, each of the plurality of features corresponding to a an identifier, a type, and a corresponding interactive locator icon disposed on the geographic map, representative of the geographic location of the feature. In other embodiments, the interactive locator icon is color-coded according to a feature type. Also, upon mouseover of the interactive locator icon, a record of a feature characteristic is displayed. In yet other embodiments, the horizontal header is representative of a plurality of selected dates and the vertical header is one of a number of rooms, number of guests, and bed size.

A method for searching also is provided. The method includes providing a first vacation property characteristic; providing a second vacation property characteristic; and providing a vacation rental property database, having a property record described by at least the first and the second characteristic. The method continues by searching the vacation rental property database according to the first and the second characteristics using a property search engine, also by identifying a property record corresponding to the first and the second characteristics, wherein the property record identifies a property address; and then displaying the property record in the cell of a grid display.

Embodiments of the method also include determining a first characteristic range having horizontal range delimiters; determining a second characteristic range having vertical range delimiters; creating a plurality of coupled, color-coded, interactive cells forming a grid coinciding with respective horizontal range delimiters and respective vertical range delimiters; searching property value records of the vacation rental property database according to a respective horizontal and a respective vertical range delimiter; counting property value records of the vacation rental property database according to a respective horizontal and a respective vertical range delimiter and providing a property count therefor; determining an average property value for property value records corresponding to a selected respective horizontal and a selected respective vertical range delimiter; and displaying the property count and the average property value in a coupled, color-coded, interactive cell for the selected respective horizontal and the selected respective vertical range delimiter. The coding corresponds to a third characteristic, the third characteristic being represented by one of three colors with a first color corresponding to a high property price, a second color corresponding to medium property price, and a third color corresponding to low property price.

In general, the first characteristic range corresponds to a range of dates including a selected date, the second characteristic range corresponds a range of accommodations, including a selected accommodation, and the cell corresponding to the selected and selected accommodation is color-coded according to price.

The method also can include coupling the property record with a map representation in which the property location is indicated thereon; and coupling the property record to another map representation having features indicated thereon, wherein the features are spatially displayed relative to the property record location.

In yet other embodiments, an online booking system is provided, including a vacation rental property database; a property search engine coupled to a vacation rental property database; a plurality of coupled, color-coded, interactive cells each having a record respectively therein. The cells are arranged in a grid format. A horizontal row is representative of a first characteristic, and a vertical column is representative of a second characteristic. A respective cell of the plurality of cells corresponds to the first characteristic and a second characteristic. A cell color-coding is representative of a third characteristic, wherein each of the interactive cells contains a record corresponding to the third characteristic, and wherein the record is selected by the property search engine coupled to the vacation rental database. The system also can include a plurality of coupled, interactive cells coupled to the plurality of coupled, color-coded, interactive cells. Ones of the plurality of coupled, interactive cells correspond to the third characteristic; each of the plurality of coupled, color-coded, interactive cells contains a vacation rental property record.

The vacation rental property record includes a property identifier element, a number of beds element, a number of baths element, a number of guests lodged element, a housing type element, a location element, a property photograph element, and a nightly booking price element. In yet other embodiments, the system can include a plurality of a vacation rental property databases; an attraction locator database and a geographic locator database. Each of the databases is coupled to the plurality of coupled, color-coded, interactive cells. A map of a geographic area in proximity to the vacation rental property represented by the vacation rental property record includes a map with icons color-coded according to one of attraction type or property price.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a monthly grid view of a system according to an embodiment of the invention;

FIG. 2 illustrates a weekly grid view of the system according to an embodiment of the invention;

FIG. 3 illustrates a drilling feature of the system according to an embodiment of the invention;

FIG. 4 illustrates a day matching feature of the system according to an embodiment of the invention;

FIG. 5 illustrates the process of using the system according to an embodiment of the invention;

FIG. 6 illustrates a online vacation rental system disposed according to an embodiment of the invention;

FIG. 7 is an interactive entry matrix according to an embodiment of the invention;

FIG. 8 illustrates an interactive period grid including coupled, color-coded, interactive cells according to an embodiment of the invention;

FIG. 9 illustrates an interactive, coded seasonal grid according to an embodiment of the invention;

FIG. 10 illustrates a property matrix according to an embodiment of the invention;

FIG. 11 is a mapping from a property matrix element to an interactive property record according to an embodiment of the invention; and

FIG. 12 is an embodiment of a property record and related interactive graphical mappings according to an embodiment of the invention.

### DETAILED DESCRIPTION OF EMBODIMENTS

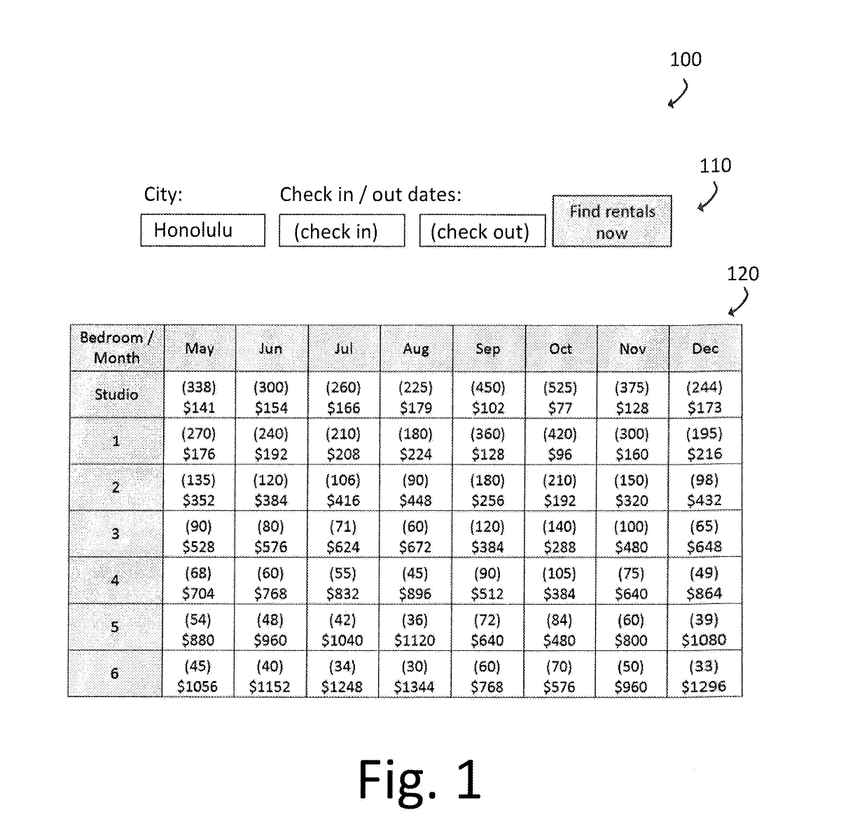

Further features and advantages of the invention, as well as the structure and operation of various embodiments of the invention, are described in detail below with reference to the accompanying FIGS. 1-12, wherein like reference numerals refer to like elements. Although the present invention outputs a grid display that illustrates a studio, up to three, or up to six bedrooms, depending upon example, but more or fewer bedrooms could be illustrated without departing from the invention. Additionally, although the search engine initially can output a month-based view prior to a week-based view, one of ordinary skill in the art readily appreciates that the present invention could output a week-based view first instead.

The present invention provides, in at least one embodiment, an intelligent search engine for vacation rentals to output to a unique grid display. In one embodiment, a method and system aggregates rental properties and provides rental availability and its nightly average rate for a vacation rental search engine. The search result is displayed via graphical grid interface that includes a monthly/weekly timeline at the horizontal axis and bedroom sizes at the vertical axis. Available units and average nightly rates are display within each cell grid.

FIG. 1 illustrates a monthly grid view of a system 100 according to an embodiment of the invention. The system 100 includes a search engine 110 and a grid of cells 120. The system 100 provides a more convenient and flexible way to search for and book vacation rentals on line.

The search engine 110 allows a traveler to search based on location and time. As illustrated, the search engine 110 provides a field for a city, fields for check in and check out dates, and a search button to find rentals now. The search engine searches a vacation rental database based on the desired location and time frame. One with skill in the art could design a different arrangement for the search engine 110 without departing from the scope of the invention. For example, the location could be a field for a zip code, county, state, country, etc.

The grid of cells 120 (e.g., monthly grid view, initial plurality of cells, etc.) displays a monthly grid view of the vacation rentals in the desired location (e.g., Honolulu) and months surrounding the desired check in and check out dates. Each of the cells is based on a number of bedrooms in a particular row and a month in a particular column.

For example, the cell in the upper left hand corner indicates that there are 338 Honolulu studios available sometime during the month of May, and the average nightly price of these available studios is $141. If the traveler is willing to delay his vacation until a non-summer month, such as October, the selection increases to 525 available studios and the average nightly price drops down to $77. As such, at a glance, a traveler can conveniently see the availability and prices for different months and bedrooms.

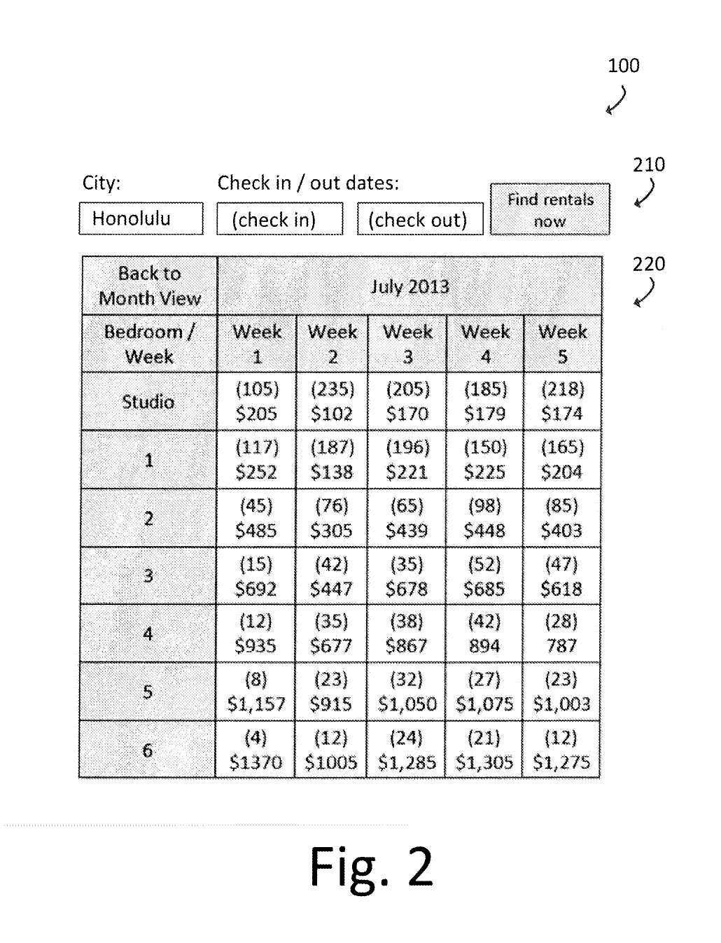

FIG. 2 illustrates a weekly grid view of the system 100 according to an embodiment of the invention. The system 100 includes a search engine 210 and a grid of cells 220. The search engine 210 can be the same as the search engine 110 described in FIG. 1. The system 100 can also include individual listings (not shown) of the vacation rentals available for the desired city and a profile picture for each.

The grid of cells 220 (e.g., weekly grid view, subsequent plurality of cells, etc.) provide a weekly display of the rentals in the desired location (e.g., Honolulu) and the weeks surrounding the desired check in and check out dates. Each cell is based on a number of bedrooms in that particular row and based on a week in that particular column.

For example, the cell in the upper left hand corner indicates that there are 105 Honolulu studios available sometime during the first week of July, and the average nightly price during the first week is $205. If the traveler is willing to delay his vacation until after the 4th of July, the second week of July has significantly more availability and lower prices, both of which may be desirable to a flexible traveler.

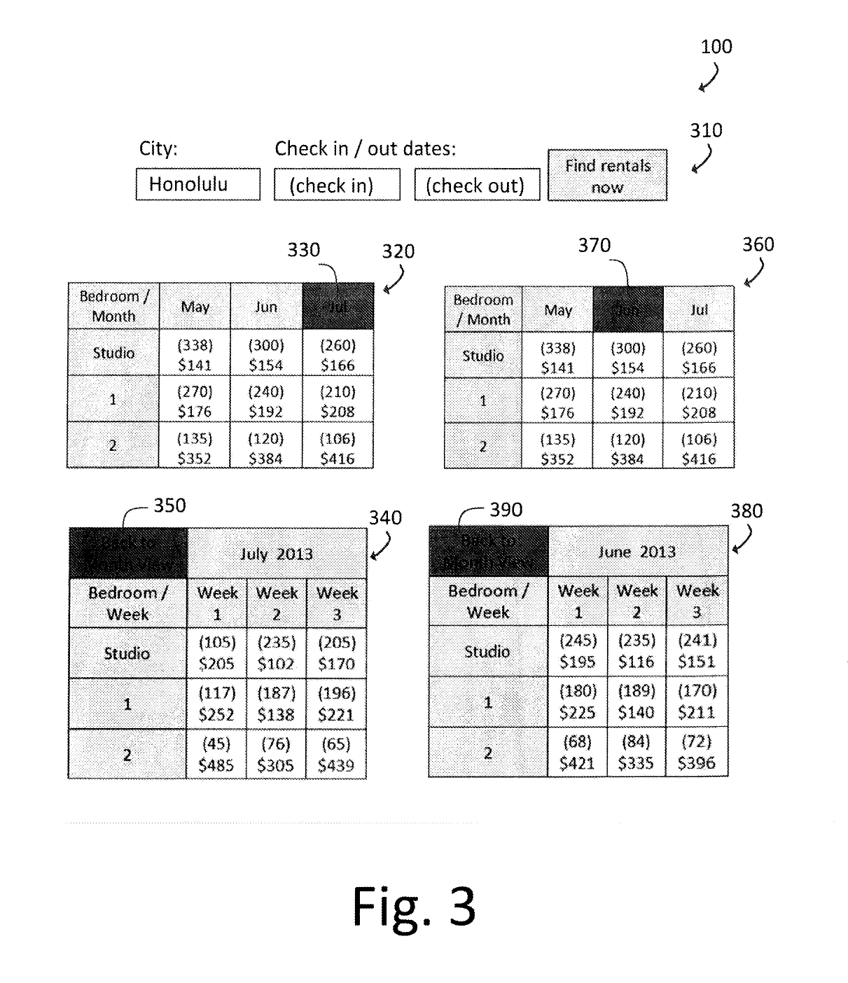

FIG. 3 illustrates a drilling feature of the system 100 according to an embodiment of the invention. The system 100 has a search engine 310 (like the search engine 110), a first grid of cells 320, a second grid of cells 340, a third grid of cells 360, and a fourth grid of cells 380. Each of the grid of cells 320, 340, 360, 380 illustrate only a limited number of months, weeks, and bedrooms to more clearly focus on the drilling down and up feature. The system 100 has a drilling down and up feature that allows the traveler to go back and forth between monthly and weekly grids views.

The first grid of cells 320 displays three bedroom options over three months. To drill down, a first selection 330 selects the month of July. In another embodiment, the first selection 330 selects any of the four cells in this column to drill down to the weeks in July. The first selection 330 drills down from the month based view 320 to the week based view 340.

The second grid of cells 340 displays three bedroom options over the first three weeks of July. To drill back up, a second selection 350 takes the traveler back to the month based view 360. One with skill in the art could design a different arrangement for going back and forth between two web pages without departing from the scope of the invention. For example, the traveler could use a browser's back button.

The third grid of cells 360 shows the same data as the first grid of cells 320. Similar to the first selection 330, to drill down again, the third selection 370 selects the month of June, drills down from the month based view 360 to the week based view 380.

The fourth grid of cells 380 displays three bedroom options over the first three weeks of June. Similar to the second selection 350, to drill up again, the fourth selection 390 takes the traveler back to the month based view 360.

This drilling feature advantageously allows a traveler to quickly and easily view vacation rentals based on different periods of time. The traveler can drill down from a particular month to a particular week, or vice a versa, to view the availability and prices for that period of time.

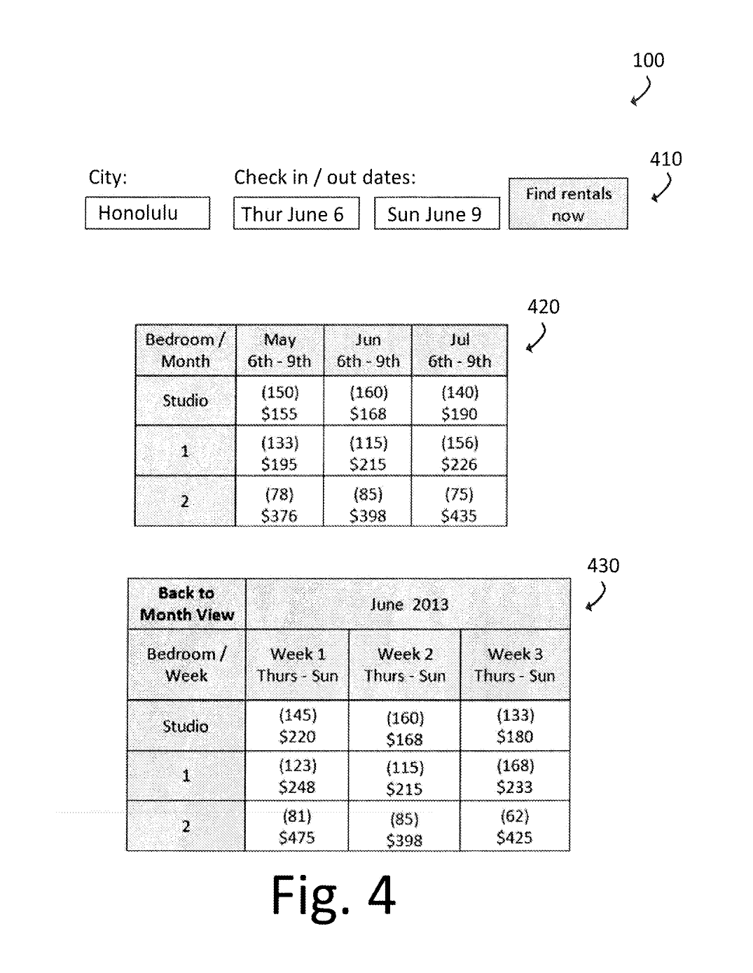

FIG. 4 illustrates a day matching feature of the system 100 according to an embodiment of the invention. The system 100 has a search engine 410 (like the search engine 110), a monthly grid of cells 420 and a weekly grid of cells 430. Each grid of cells 420 and 430 illustrate only a limited number of months, weeks, and bedrooms to more clearly focus on the day matching feature.

The system 100 illustrates the day matching feature to match days of a month (e.g., 6th through 9th) between several months in the monthly grid view and days of a week (e.g., Thursday through Sunday) between several weeks in the weekly grid view.

The monthly grid of cells 420 displays three bedroom options over three months. In this example, the desired stay is from Thursday, June 6th through Sunday, June 9th. As such, the day matching feature allows each column to maintain the desired days per month (the 6th-9th) in the monthly grid view 420. The availability and prices refer only to the desired days of the month. If the traveler drills down to the weeks of June, the weekly grid of cells 430 displays three bedroom options over three weeks. Again, the availability and prices refer only to the days of the week desired (e.g., Thursday through Sunday).

In one embodiment, the availability and price include only places that have availability over the entire check-in/check-out range. In another embodiment, the availability and price include only places that have availability over less than the entire check in/ out range.

This matching feature is beneficial for a person who typically vacations on certain times of month (e.g., first week of the month) or on certain days per week (e.g., Thursday through Sunday). By matching the days, the traveler gets an “apples-to-apples” comparison of the average nightly prices of different months or weeks.

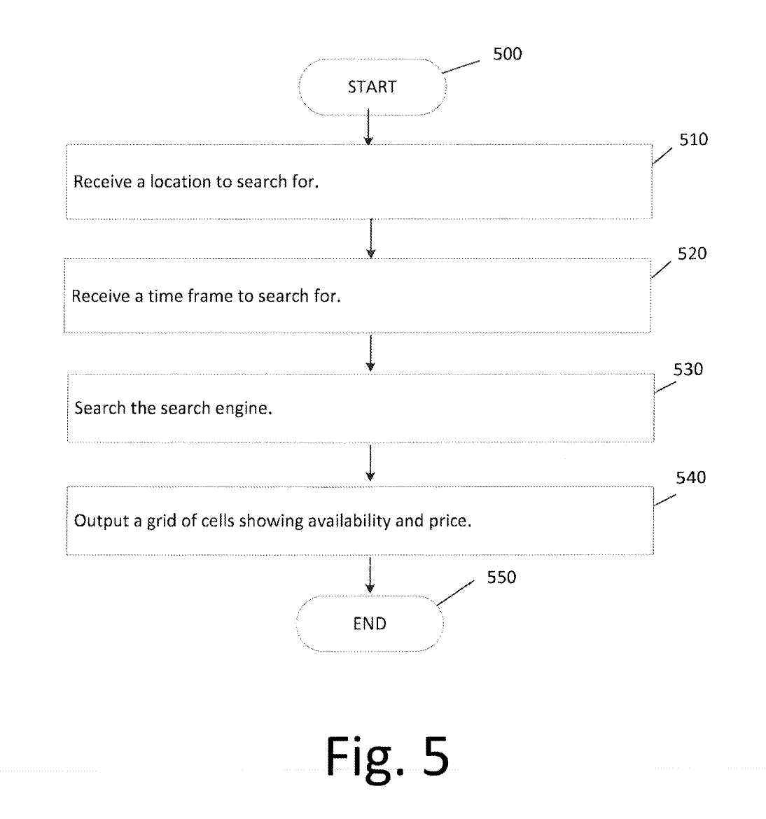

FIG. 5 illustrates the process of using the system 100 according to an embodiment of the invention. The process starts at step 500. At step 510, the system 100 receives a location to search for. In one embodiment, the system 100 is configured to receive any major city in the world. At step 520, the system 100 receives a time frame to search for. In one embodiment, the time frame is the travelers desired travel dates. The traveler hits the search button and the system searches the search engine 110 at step 530. At step 540, the system 100 outputs a grid of cells showing the availability and price based on a period of time and a number of bedrooms. The grid of cells can be a monthly grid 120 or a weekly grid 220. The process may be repeated recursively a number of times and ends at step 550.

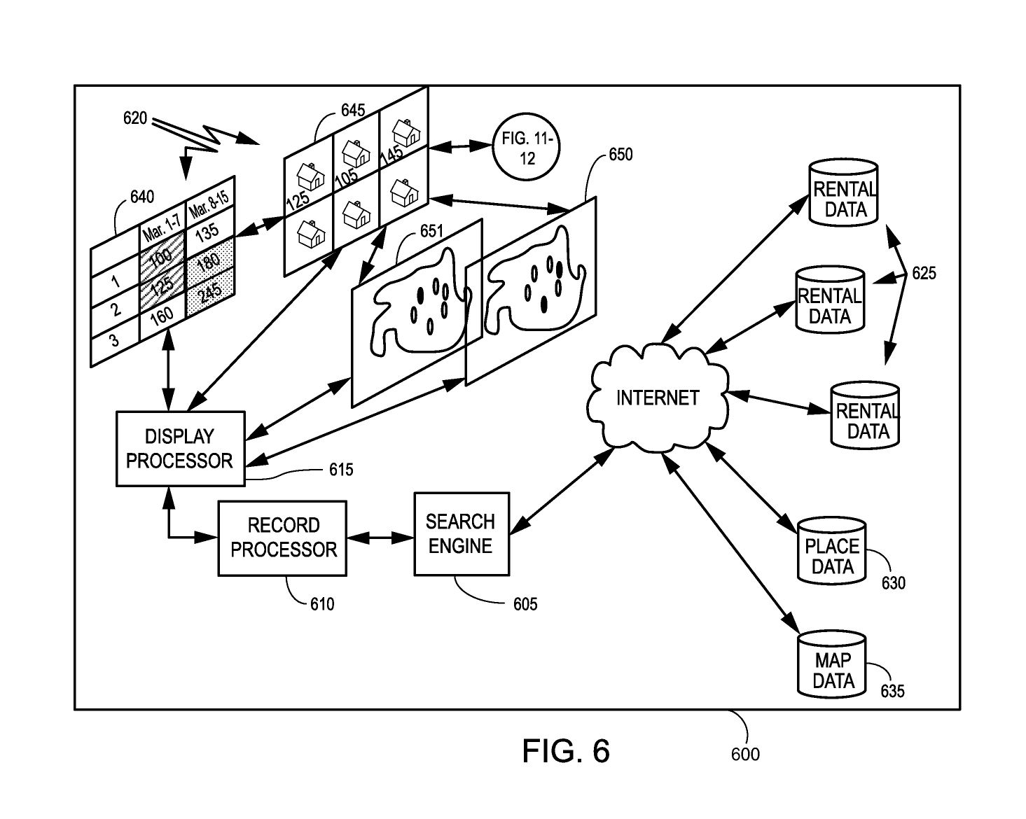

FIG. 6 is a graphical depiction of an embodiment of an online vacation rental system 600. System 600 includes a search engine 605, record processor 610, display processor 615, and interactive graphical user interface 620, which together searches, identifies, selects, and displays vacation rental system records to a user (not shown) of system 600. Search engine 605 can be a hospitality search engine coupled to vacation rental databases, generally at 625, which may be provided by one or more property vendors. Search engine 605 also may be coupled to a property mapping database 630, and maybe a spatial map database containing interactive geospatial mapping 636 ability for areas surrounding and including selected vacation rental properties. Attraction database 635 allows geospatial mapping 638 of featured places, such as, without limitation, dining and drinking establishments, which may be in proximity to selected vacation rental properties. A ratings and recommendation database 634 may also be employed, in which the ratings and recommendations may correspond to the featured places in mapping 638. Access to such a database, which may be a YELP® database, may be implemented using YELP® API, available at http://www.yelp.com/developers/documentation, from YELP®, San Francisco, Calif.

Information pertaining to vacation rental properties is contained in vacation rental properties records which, after selection by search engine 605, are processed by record processor 610. Record processor 610 can provide information regarding one or more vacation rental properties, and may provide all or part of vacation rental properties records depending upon the context of presentation.

Vacation rental properties records include multiple records pertaining to the corresponding vacation rental property including, without limitation, vacation rental property identification, vacation rental property type, vacation rental property location, vacation rental property number of bedrooms, number of guests that can be lodged at the property, number of bathrooms, average nightly booking rate on a specific day or range of dates, and narratives information regarding the ambience, amenities, or both corresponding to the property. Record processor 610, for example, can be capable of determining average nightly booking rates for a single vacation rental property or over a plurality of selected vacation rental properties records. In certain embodiments, search engine 605 finds a plurality of records matching preselected criteria, and records processor 610 determines the average nightly booking rate for a type of accommodation, such as number of rooms, over preselected time periods, such as one or more selected weekly or monthly time periods.

Other records, such as featured place and spatial information records, can be processed by record processor 610, which may color code selected featured place and spatial information records to assist the user (not shown) in comprehending the information at-a-glance. Display processor 615, collects the records provided by records processor 610 and interactively couples them to interactive graphical user interface (GUI) 620, where the user (not shown) may view, understand, select, or manage the data records provided by records processor 610. Display processor 615 can be adapted to display one or more records in grid or matrix form. GUI 620 may include coupled, color-coded, interactive price grid 640, interactive property matrix 645, or one or more interactive maps 650, 651.

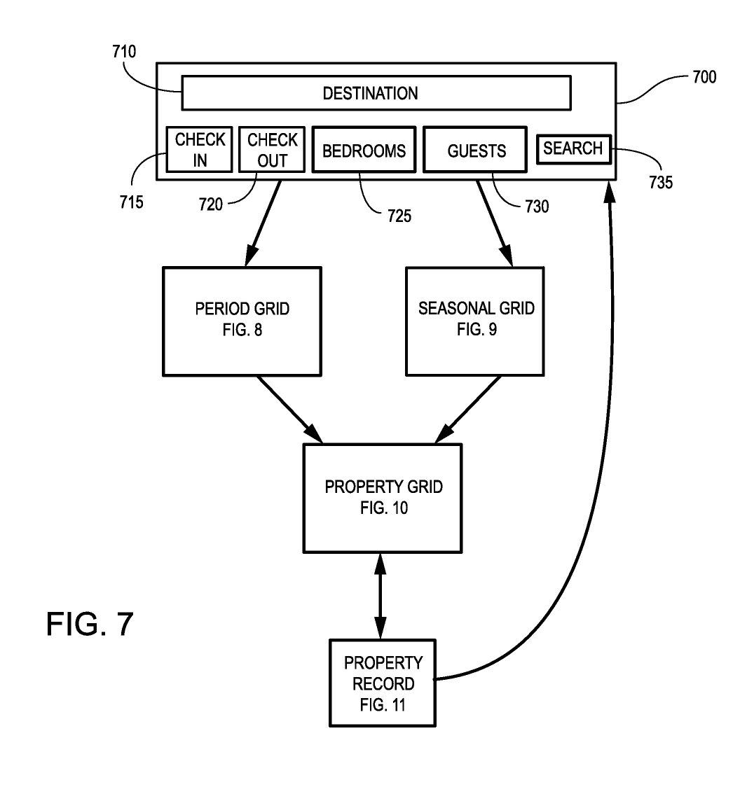

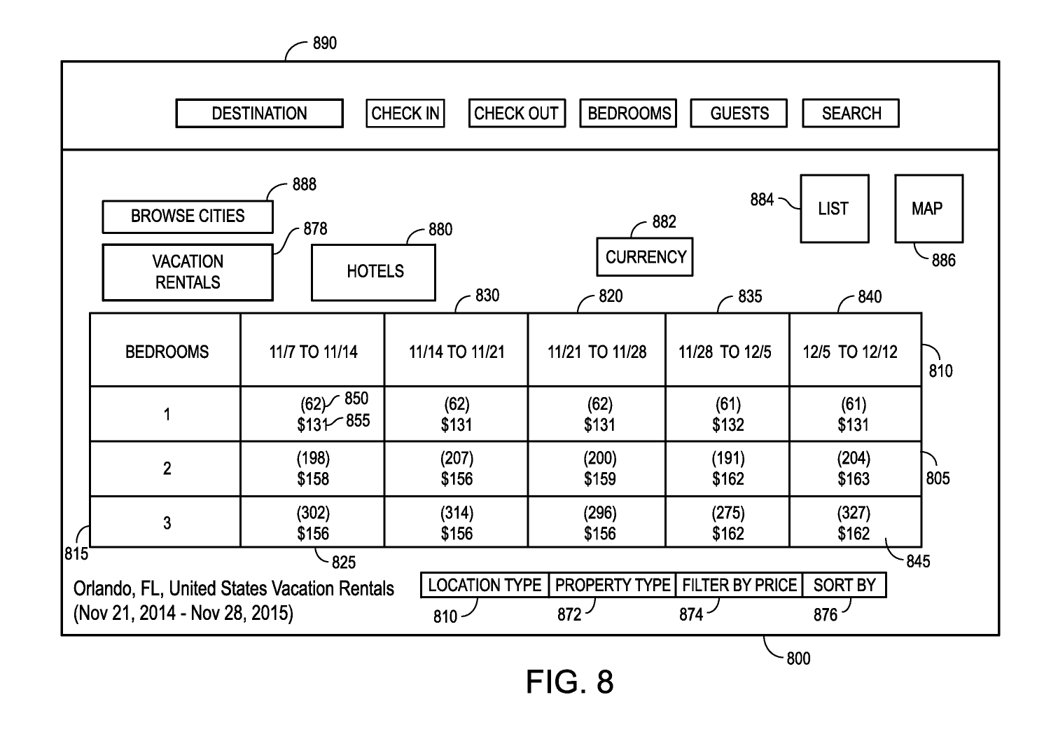

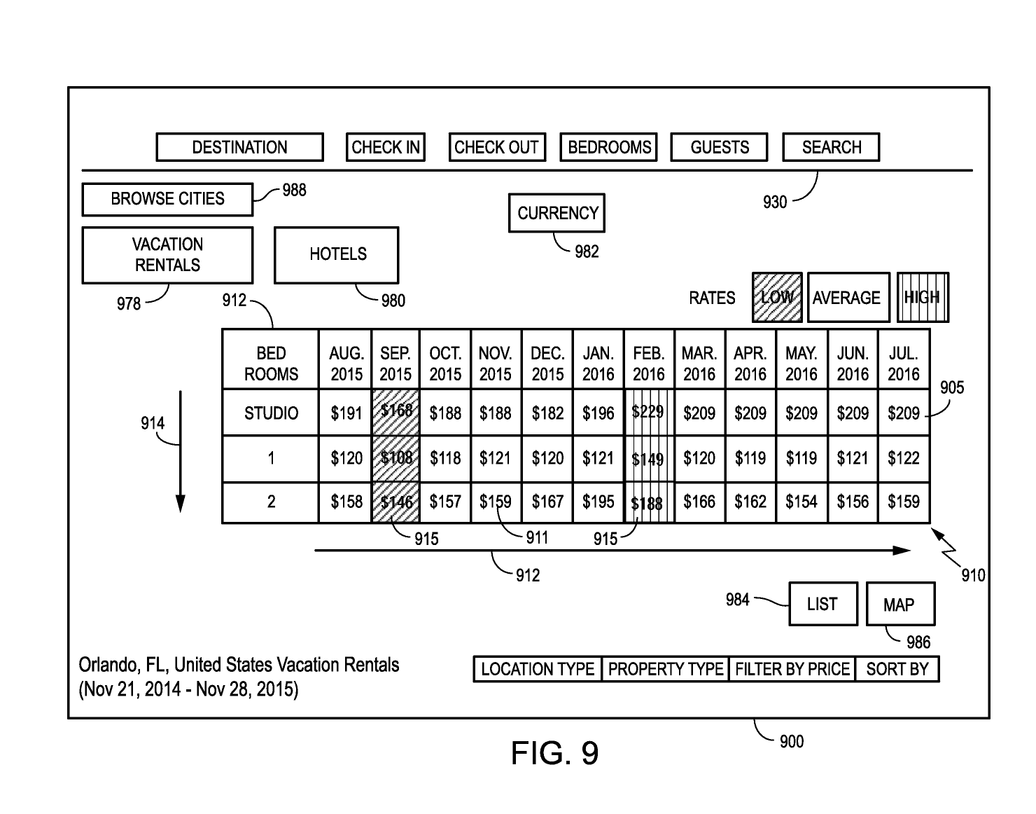

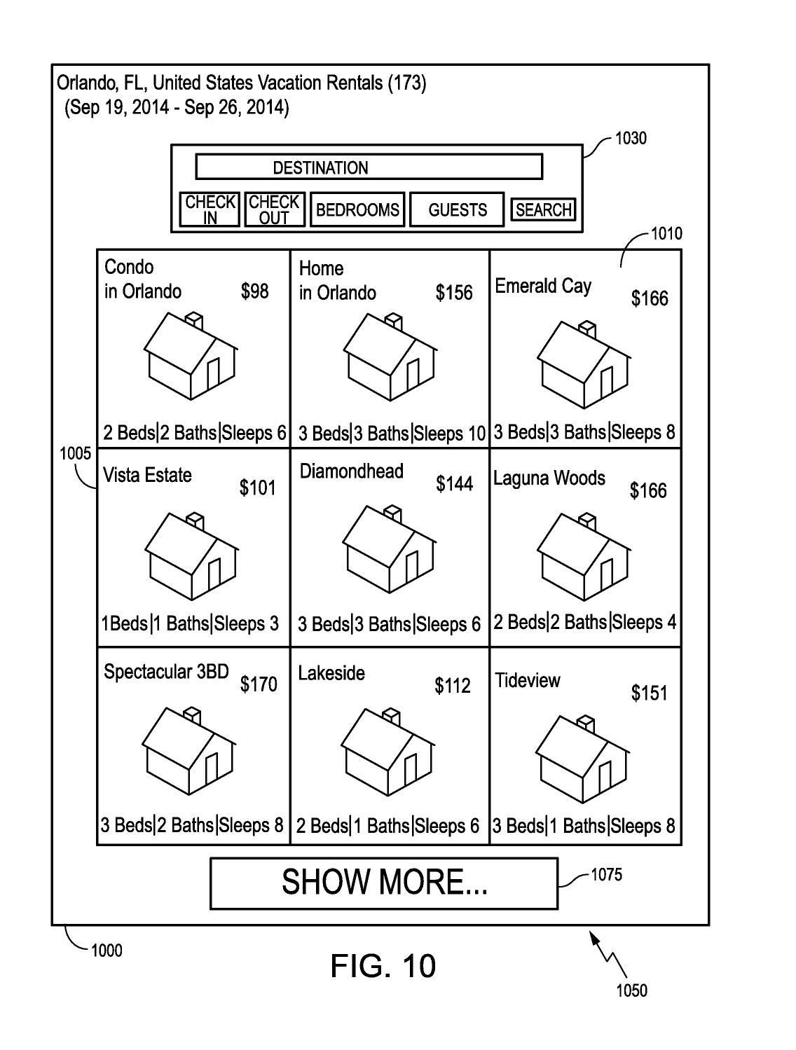

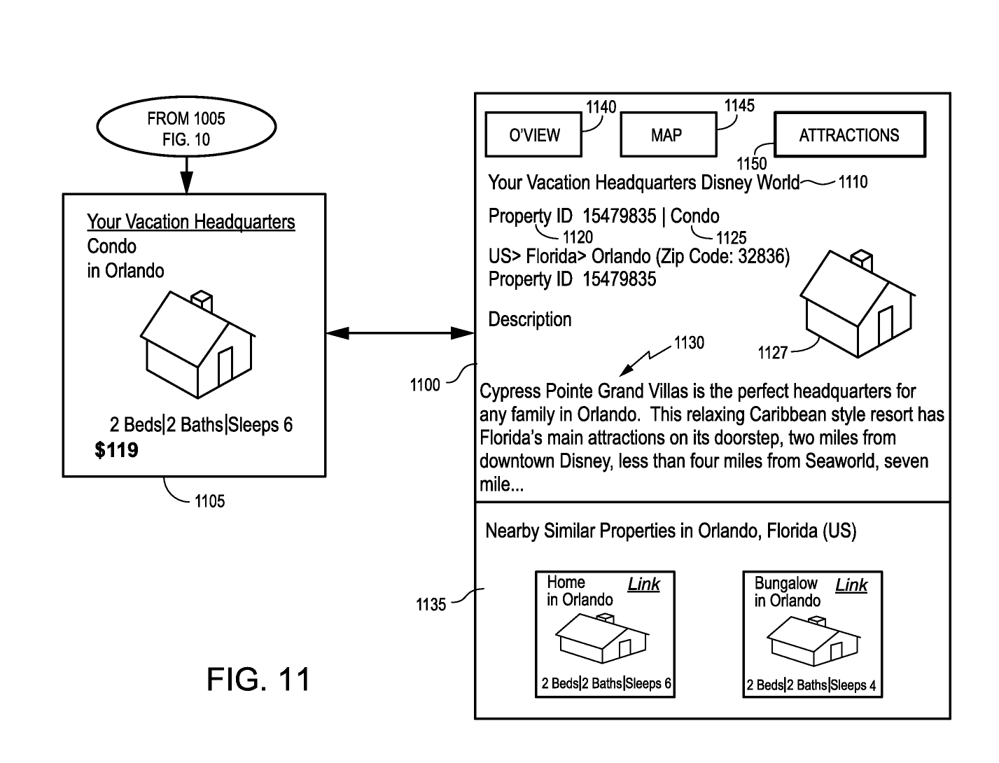

FIG. 7 illustrates one embodiment of a vacation data entry matrix 700, which is one way to enter an embodiment of an online vacation rental booking system. Matrix 700 can include an element of interaction in a graphical user interface element (widget) 710 disposed to receive vacation destination data; a check-in widget 715, which may be disposed as a selectable calendar for selecting potential check in date data; a check-out widget 720, which may be disposed as a selectable calendar for selecting potential check out date data; a bedroom widget 725, which may implemented as a drop down menu, disposed to receive data representing the number of bedrooms sought by the prospective vacationer in a vacation property; a guest widget 730, which may implemented as a drop down menu, disposed to receive data representing the number of guests sought to be lodged in a vacation property by the prospective vacationer; and a search initiation widget 735, which may be implemented as an action button, which urges the booking system search engine (not shown) to search for and display vacation properties meeting the characteristics of the data entered by the prospective vacationer and to return a bracket-grid bearing property data records. For example, period matrix 800 may be provided (See FIG. 8), or seasonal matrix 900 may be provided (See FIG. 8), depending upon the data provided by the user in the widgets. As another example, by entering a check-in/check-out date in widgets 715, 720, a period matrix 800 can be presented to the user, whereas, by not entering a check-in/check-out date in widgets 715, 720, seasonal matrix 900 can be presented. The information provided in matrix 700 can be used with period grid in FIG. 8, Seasonal Grid in FIG. 9, or property grid in FIG. 10. Through the selection process by the user, the information selected can be property record in FIG. 11 may be representative of a vacation rental property desired by the user. However, property record in FIG. 11 provides the user with the capability of returning to the property grid in FIG. 11 or matrix 700 in FIG. 7.

In FIG. 8, period grid 805 may be represented as an interactive element of period matrix 800. Matrix 800 may have other interactive elements. In an embodiment, matrix 800 also may include data entry matrix 890 similar in form and function to vacation data entry matrix 700 in FIG. 7. Period grid 805 may have a horizontal header 810 and a vertical header 815. Header 810 can be composed of non-interactive graphical cells indicating the number of bedrooms, or the identities of the weeks preceding, including, and following the check in and check out date data entered in check-in widget 715 and check out widget 720 in FIG. 7. In a non-limiting example, “target” vacation date range 820 (here, 11/21 to 11/28) is bracketed to the left by similar period 825 (here 11/7-11/14), and similar period 830 (here, 11/14-11/21) preceding “target” vacation date range 820. Date 820 can be bracketed to the right by similar period 835 (here, 11/28-12/5) and similar period 840 (here, 12/5-12/12) following “target” vacation date range 820. Although periods 820, 825, 830, and 835 are illustrated as a week, other periods can be used, for example, three and one-half weeks. Down vertical header 815 is listed a bracketed number of bedrooms pertaining to the “target” number of bedrooms selected by bedroom widget 725. For example, if the prospective vacationer selected a two bedroom preference, one and three bedrooms also is shown. Had the prospective vacationer selected a five bedroom preference, four and six bedrooms also can be shown. Note that, in alternative embodiments, other features, including number of guests or lodgers, or bed size (e.g., “King,” or “Queen”) may be selectable in addition to or in substitution of the target number of beds in header 815.

Nested in the vertical and horizontal headers can be a coupled, interactive grid 805, composed of cells disposed in a grid-like arrangement. Each cell 845 of grid 805 includes property count record 850 and average rate record 855, as may be produced by record processor 610 in FIG. 6. In embodiments, average rate record 855 can be an average nightly rate record. Thus, at a glance, a prospective vacationer can see the average nightly rate for bedroom bracket 815, and period bracket 825, informing the vacationer not only of what the average rate and availability of occupancies are for the selected period and selected number of beds, but also of what the average rate and availability of occupancies for adjacent time periods and number of beds. A prospective traveler may be alerted to less expensive or more costly periods and number of beds. Upon mouseover of each cell, a “tooltip” showing the availability and average rate appears.

Period matrix 800 also can include filter features including, without limitation, location type filter 870, property type filter 872, filter by price 874, or a sort-by filter 876, which may be implemented as drop-down menus. Location type filter 870 enables a prospective vacationer to choose a vacation property by type of location, such as beach, downtown, golf, lake, mountain, near the ocean, skiing, waterfront, other, or any. Property type filter 872 enables a prospective vacationer to choose a vacation property by type of property, such as apartment, bed & breakfast, bungalow, cabin, campsite, castle, castle/mansion, chalet, chateau, condo, cottage, couch, divers, dorm, estate, farmhouse, finca, gite, house, hostel, holiday village, igloo, lodge, loft, lighthouse, manor, monastery, penthouse, resort, room, residence, studio, self-catering apartment, self-catering villa, timeshare, townhouse, treehouse, unit, villa, yacht/boat, other, or any. Filter-by-price 874 enables a prospective vacationer to choose a vacation property by average nightly rate price range, for example, $1-$99, $100-$199, $200-$299, $300-$399, $400-$499, $500+, or “any”. Sort-by filter 876 enables a prospective vacationer to choose a vacation property by distance, price: low to high, or price: high-to-low. Of course, all of the following examples may have substitutions of other entities.

Period matrix 800 also may include vacation rental selector 878, hotel selector 880, currency selector 882, list selector 884, map selector 886, or cities selector 888. From the period matrix 800, vacation rental selector 878 can advance the user to seasonal grid 900, which will be described more completely in FIG. 9. Hotel selector 880 can advance the user to a property matrix represented as a webpage featuring hotel rooms, similar in form to a property matrix of vacation rental properties, which will be described in FIG. 10. Currency selector 882 can be used to convert the displayed average nightly rate 855 to one of many rates, such as U.S. dollars, Australian dollars, British pounds, Canadian dollars, Euros, and Hong Kong dollars. Of course, other currencies may be added to currency selector 882. This tool 882 may be useful to international visitors seeking a vacation rental property. List selector 884 can be coupled to map selector 886. Map selector 886 may display properties associated with grid 805 in a geographical spatial arrangement (a map), color-coded to indicate average nightly rates. List selector 884 can return the view of properties back to a list arrangement.

Turning to FIG. 9, at least one embodiment of seasonal matrix 900, a coupled, color-coded, interactive grid 905 can be provided, containing a plurality of color-coded cells (generally at 910). Grid 905 can be configured to illustrate at least one vacation rental booking rate, such as an average nightly booking rate 911 for booking periods in a predetermined booking period, for example, an annual period and for a selected accommodation, for example, the number of bedrooms. The plurality of color-coded cells 910 can have a horizontal dimension 912 representative of a first characteristic, and a vertical dimension 914 representative of a second characteristic. The color-coding 915 of the coupled, color-coded, interactive cell 910 can be representative of a third characteristic. In a non-limiting example, a record displayed in the coupled, color-coded, interactive cell 910 can be an average rental booking rate 911 relative to preselected time period, such as per-night. The horizontal dimension 912 representative of a first characteristic can be time, in one example, displayed as continuous months bracketing a selected month of proposed vacation rental property occupancy, grouped by horizontal delimiters, here months. The vertical dimension 914 representative of a second characteristic can be an accommodation attribute grouped by vertical delimiters. An accommodation attribute 912 can be at least one of number of bedrooms in a vacation rental, a number of guests that can be lodged, a bed type (e.g., king, queen, twin, etc.) available in a bedroom, or a combination thereof. The third characteristic color-coding 915 may be representative of a relatively low nightly booking rate, a relatively average nightly booking rate, and a relatively high nightly booking rate, all relative to the season and/or week for which the prospective vacationer seeks information. For example, in Sept. 2015, which may be “off-season,” the average nightly booking rate can be relatively low, compared to other months, e.g., a one bedroom vacation rental can cost about $108 per night. The corresponding cell can be color coded for a selected “LOW” range. Continuing with the example, a one bedroom vacation rental in Feb. 2016, which may be peak “season,” the average nightly booking rate can be relatively high, compared to other months, e.g., a one bedroom vacation rental can cost about $149 per night. The corresponding cell can be color coded for a selected “HIGH” range. In between the selected “LOW” range and the selected “HIGH” range can be a selected “AVERAGE” range, which may be determined, for example, by record processor 610 in FIG. 6 determining the low, mid-range and high average value, for example, from each record in vacation rental databases 625 in FIG. 6. In an embodiment, matrix 900 also may include data entry matrix 930 similar in form and function to vacation data entry matrix 700 in FIG. 7. In addition, matrix 900 can include vacation rental selector 978, hotel selector 980, currency selector 982, list selector 984, map selector 986, or cities selector 988. Each of the selectors 978, 980, 982, 984, 986, and 998 have similar functionality to selectors 878, 880, 882, 884, 886, and 898, respectively, as described with respect to FIG. 8. Further, matrix 900 also can include filter features including, without limitation, location type filter 970, property type filter 972, filter by price 974, or a sort-by filter 976, which may be implemented as drop-down menus. These are similar in function to filters 870, 872, 874, and 876 described with respect to FIG. 8.

FIG. 10 illustrates a vacation rental property matrix 1000 composed of the vacation rental property records, generally arranged in a grid at 1005, including pictorial representation of a selected number of vacation rental properties. Preferably each element 1010 of matrix 1000 has some pictorial representation, although that is not a requirement. Pictorial representation can be stored, retrieved, and displayed in the form of a record. Each matrix element generally includes a property location, property type, and an average nightly rental rate for the selected period. The pictorial matrix appearance allows a user to see properties at-a-glance, along with property booking rate, and rental unit size (e.g., number of bedrooms, baths, and number of potential lodgers).

In certain embodiments, such as seen in FIG. 10, webpage 1050 of the online vacation rental system, may include a coupled pairing of period matrix 800 and vacation rental property matrix 1000, or a coupled pairing of seasonal matrix 900 and vacation rental property matrix 1000. In certain embodiments, period matrix 800 or seasonal matrix 800 can be displayed in an upper portion of 1050 webpage, and vacation rental property matrix 1000 can be displayed in a lower portion of webpage 1050. Vacation rental property record 1005 displayed in property matrix 1000 can be coupled to the parameters selected for period matrix 800 or seasonal matrix 900. Also, webpage 1050 can include a vacation data entry matrix 1030 such as matrix 700 in FIG. 7. Further, webpage 1050 can have an interactive widget 1075, which permits a user to see more vacation rental properties than those shown on webpage 1050.

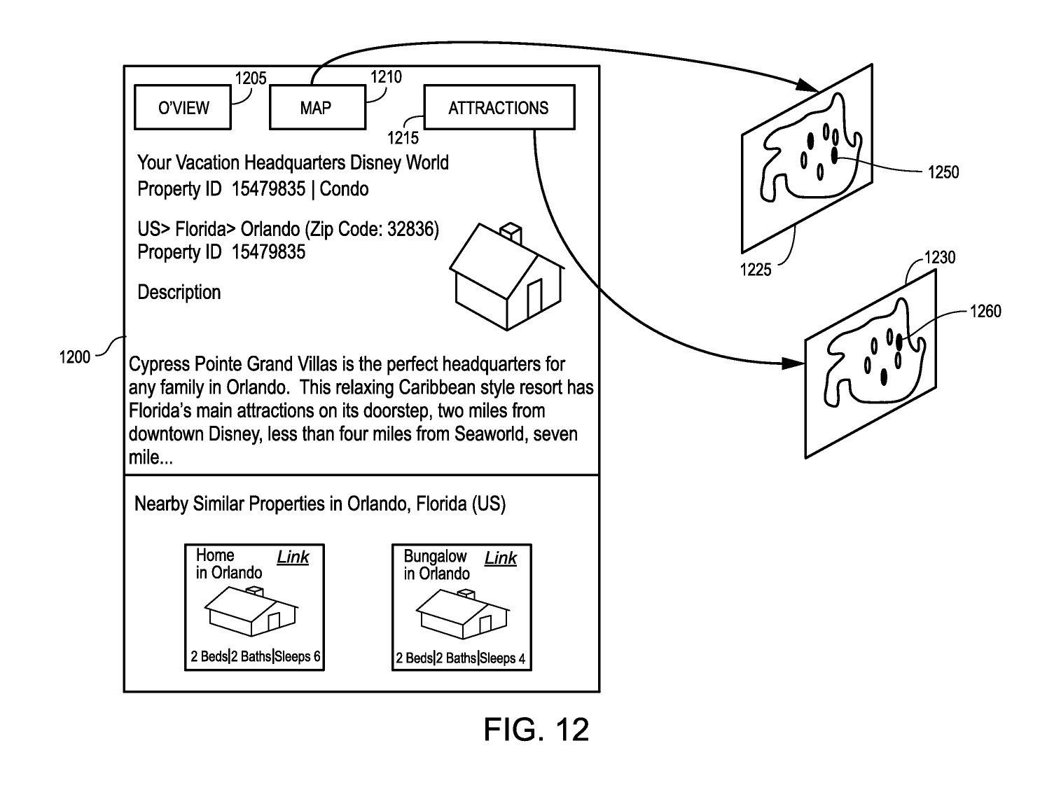

Vacation rental property record 1105, in FIG. 11, which can be similar to vacation rental property record 1005 in FIG. 10, can be coupled to vacation property identifier record 1100. Record 1100 can include title 1110 describing the record or property, geophysical location 1115, such as a postal zipcode, city, or both, property record number 1120, and property type 1125. A photographic representation 1127 of the property may be provided. Further, narrative 1130 can be included in record 1105. Narrative 1130 can be provided as a written description of the property qualities, as well as a written description having a list of amenities. Conveniently, a shorter listing of like properties 1135 may be displayed beneath record 1105 information, which may aid the user in finding a suitable vacation rental property. Page 1100 also may include overview widget 1140, map widget 1145, and attractions widget 1150. Page 1100 is depicted as in the overview (“o'view”) mode, with data and narrative displayed. Map and attractions widgets can be explained in FIG. 12.

FIG. 12 illustrates additional interactive capabilities which may be provided to vacation rental property record 1200, for example, overview widget 1205, geographic locator widget 1210, and attractions locator widget 1215. Record 1200 is similar to record 1100. When selected, geographic locator 1210 cause the display processor to show each of a selected number of vacation properties being indicated on map 1225 with color-coded icon 1250. The vacation property map 1225 can be made available by choosing a “MAP” selector (geographic locator widget 1210). Using MAP selector 1210, a prospective vacationer can tell at-a-glance where properties are spatially located relative to each other and relative to geographic features, such as a beach, a mountain, a street, a park, an interstate highway, and other places of interest depicted on map 1225. Color-coding, again, may be used to indicate a pricing range of the property. In particular, color-coding of the color-coded icons can be used to depict the price-per-night range of a vacation property. The prospective vacationer may be able to use the color-coded icons and geospatial location to decide where to select a vacation rental property relative to geographic features and nightly price range of a vacation rental property. Such map 1225 may be generated by way of GOOGLE® MAPS API, from GOOGLE®, Mountain View, Calif. USA, and available at https://developers.google.com/maps.

Yet further coupled to vacation rental property record 1200 can be attractions geographic locator widget 1215 which, when selected can produce attractions locator, or map 1230. Using map 1230, a prospective vacationer can tell at-a-glance where features are relative to the geographic region in which vacation rental properties of interest are located, each using color-coded icon 1260. Features can include, without limitation, entertainment, dining, and drinking locations, venues, and services. Such map 1230 may be generated by way of GOOGLE® PLACES API, from GOOGLE®, Mountain View, Calif. USA, and available at https://developers.google.com/places. Color-coding of icons can help the prospective vacationer, at a glance, differentiate from among different types of features, for example, a restaurant or a bar.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A property search engine interface, comprising: a plurality of coupled, color-coded, interactive cells each having a record respectively therein, the cells arranged in a grid format, wherein a horizontal row is representative of a first characteristic, wherein a vertical column is representative of a second characteristic, wherein a respective cell of the plurality of cells corresponds to the first characteristic and a second characteristic, wherein a cell color-coding of the cell is representative of a third characteristic, wherein each of the interactive cells contains a record corresponding to the third characteristic, and wherein the record is selected by a search engine coupled to a vacation rental database.

2. The property search engine interface of claim 1, wherein the first characteristic is a time characteristic, the second characteristic is an accommodation characteristic, the third characteristic is an average nightly price characteristic, and the record corresponds to an average nightly price record related to the time characteristic and the accommodation characteristic.

3. The property search engine interface of claim 1, wherein the accommodation characteristic is at least one of a number of bedrooms, a number of guests, or a bed size.

4. The property search engine interface of claim 1, comprising a plurality of coupled, interactive display cells having at least one record corresponding to the time characteristic, the accommodation characteristic, and the average nightly price record, each of the display cells providing a property record, an accommodation record, a property type, and a property location.

5. The property search engine interface of claim 1, further comprising an entry page having a destination entry, a start date entry, an end date entry, a size entry, a guest number entry, and search engine activation device.

6. The property search engine interface of claim 4, wherein each of the plurality of coupled, interactive display cells is coupled to a geographic map having an interactive locator icon representative of the property location on the geographic map.

7. The property search engine interface of claim 4, wherein each of the plurality of coupled, interactive display cells is coupled to a geographic map representation having a feature chart corresponding to a plurality of features, each of the plurality of features corresponding to a an identifier, a type, and a corresponding interactive locator icon disposed on the geographic map, representative of the geographic location of the feature.

8. The property search engine interface of claim 7, wherein the interactive locator icon is color-coded according to a feature type.

9. The property search engine interface of claim 7, wherein upon mouseover of the interactive locator icon, a record of a feature characteristic is displayed.

10. The property search engine interface of claim 1, wherein ones of the plurality of cells further comprise a second record corresponding to the third characteristic.

11. The property search engine interface of claim 1, wherein the second record comprises the number of locations corresponding to the third characteristic.

12. The property search engine interface of claim 1, further comprising a horizontal header above the plurality of cells and a vertical header to a side of the plurality of cells.

13. The property search engine interface of claim 12, wherein the horizontal header is representative of a plurality of selected dates and the vertical header is one of a number of rooms, number of guests, and bed size.

14. A method for searching, comprising:
providing a first vacation property characteristic;
providing a second vacation property characteristic;
providing a vacation rental property database, having a property record described by at least the first and the second characteristic;
searching the vacation rental property database according to the first and the second characteristics using a hospitality search engine;
identifying a property record corresponding to the first and the second characteristics, wherein the property record identifies a property address; and
displaying the property record in the cell of a grid display.

15. The method of claim 14, further comprising;
determining a first characteristic range having horizontal range delimiters;
determining a second characteristic range having vertical range delimiters;
creating a plurality of coupled, color-coded, interactive cells forming a grid coinciding with respective horizontal range delimiters and respective vertical range delimiters;
searching property value records of the vacation rental property database according to a respective horizontal and a respective vertical range delimiter;
counting property value records of the vacation rental property database according to a respective horizontal and a respective vertical range delimiter and providing a property count therefor;
determining an average property value for property value records corresponding to a selected respective horizontal and a selected respective vertical range delimiter; and
displaying the property count and the average property value in a coupled, color-coded, interactive cell for the selected respective horizontal and the selected respective vertical range delimiter.

16. The method of claim 15, wherein color coding corresponds to a third characteristic, the third characteristic being represented by one of three colors with a first color corresponding to a high property price, a second color corresponding to medium property price, and a third color corresponding to low property price.

17. The method of claim 15, wherein the first characteristic range corresponds to a range of dates including a selected date, the second characteristic range corresponds a range of accommodations, including a selected accommodation, and wherein the cell corresponding to the selected and selected accommodation is color-coded according to price.

18. The method of claim 14, further comprising:
coupling the property record with a map representation in which the property location is indicated thereon.

19. The method of claim 18, further comprising:
coupling the property record to another map representation having features indicated thereon, wherein the features are spatially displayed relative to the property record location.

20. An online booking system, comprising:
a vacation rental property database;
a hospitality search engine coupled to the a vacation rental property database;
a plurality of coupled, color-coded, interactive cells each having a record respectively therein, the cells arranged in a grid format, wherein a horizontal row is representative of a first characteristic, wherein a vertical column is representative of a second characteristic, wherein a respective cell of the plurality of cells corresponds to the first characteristic and a second characteristic, wherein a cell color-coding is representative of a third characteristic, wherein each of the interactive cells contains a record corresponding to the third characteristic, and wherein the record is selected by the hospitality search engine coupled to the vacation rental database.

21. The system of claim 20, further comprising:
a plurality of coupled, interactive cells coupled to the plurality of coupled, color-coded, interactive cells, wherein ones of the plurality of coupled, interactive cells correspond to the third characteristic, wherein each of the plurality of coupled, color-coded, interactive cells contains a vacation rental property record, wherein the vacation rental property record includes a property identifier element, a number of beds element, a number of baths element, a number of guests lodged element, a housing type element, a location element, a property photograph element, and a nightly booking price element.

22. The system of claim 20, further comprising:
a plurality of a vacation rental property databases;
an attraction locator database and
a property locator database,
wherein each of the databases are coupled to the plurality of coupled, color-coded, interactive cells,
wherein a map of a geographic area in proximity to the vacation rental property represented by the vacation rental property record includes a map with icons color-coded according to one of attraction type or property price.
